(19) United States
(12) Patent Application Publication
(10) Pub. No.: US 2009/0270284 A1
(43) Pub. Date: Oct. 29, 2009

(54) FRICTION MODIFIER, METHOD OF PRODUCING FRICTION MODIFIER, AND FRICTION MATERIAL

(75) Inventors: Katsuhiro KIKUCHI, Tokyo (JP); Motoki KUROE, Tokyo (JP); Hiroshi IDEI, Tokyo (JP)

Correspondence Address: DRINKER BIDDLE & REATH (DC), 1500 K STREET, N.W., SUITE 1100, WASHINGTON, DC, 20005-1209, US

(73) Assignee: AKEBONO BRAKE INDUSTRY CO., LTD, TOKYO (JP)

(21) Appl. No.: 12/430,288

(22) Filed: Apr. 27, 2009

(30) Foreign Application Priority Data
Apr. 28, 2008 (JP) P2008-117560

(51) Int. Cl. F16C 33/24

(52) U.S. Cl. 508/108; 508/165

(57) ABSTRACT

A friction modifier is provided with a titania particle-layered clay mineral complex in which titania particles are contained in a layered clay mineral. An average particle diameter of the titania particles is 3 to 100 nm. A ratio of the titania particles to the titania particle-layered clay mineral complex is 0.1 to 0.8 on the mass basis.

### BACKGROUND OF THE INVENTION

1. Field of the Invention

This invention relates to a friction modifier, a method of producing the friction modifier and a friction material.

More particularly, the invention relates to a friction modifier which is suitably usable in brake friction materials for automobiles, railway vehicles, industrial machines and so on and friction materials for clutch facings of automobiles, a method of producing the same and a friction material.

2. Background Art

In recent years, there have been developed brake friction materials in which zeolite that is a layered clay mineral is used together with antimony oxide or the like to thereby regulate a generation of noises during a braking (see, for example, Patent Document 1).

PATENT DOCUMENT 1: JP-A-2001-181607

However, the friction material disclosed in Patent Document 1 shows a decrease in a fade resistance in the case where the content of antimony oxide exceeds 2% by mass. Moreover, antimony compounds per se are listed in Pollutant Release and Transfer Register Laws (PRTR) established from the standpoint of the environmental protection. Accordingly, an antimony compound-free friction material has been required in these days.

### SUMMARY OF THE INVENTION

One or more embodiments of the invention provide a porous friction modifier by which a wear amount in sliding at a high temperature of a friction material can be reduced and a decrease in a friction coefficient of a friction material can be inhibited without resorting to use an antimony compound, a method of producing such friction modifier, and a friction material containing such friction modifier.

In accordance with one or more embodiments of the invention, a friction modifier is provided with a titania particle-layered clay mineral complex in which titania particles are contained in a layered clay mineral. In the friction modifier, an average particle diameter of the titania particles is 3 to 100 nm, and a ratio of the titania particles to the titania particle-layered clay mineral complex is 0.1 to 0.8 on a mass basis.

Moreover, in accordance with one or more embodiments of the invention, a friction material is provided with a friction modifier including a titania particle-layered clay mineral complex in which titania particles are contained in a layered clay mineral in which an average particle diameter of the titania particles is 3 to 100 nm, and a ratio of the titania particles to the titania particle-layered clay mineral complex is 0.1 to 0.8 on a mass basis. The friction material is free from an antimony compound.

The friction material may include: 0.5 to 20% by mass of the friction modifier; a fiber reinforcement; a binder resin; and a filler.

Moreover, in accordance with one or more embodiments of the invention, a friction modifier including a titania particle-layered clay mineral complex in which titania particles are contained in a layered clay mineral is produced by the method of: bringing a titanium compound having a hydrolyzable group or a hydroxyl group and carrying 0 to 60 carbon atoms in total in its molecule into contact with a layered clay mineral, in an aqueous medium, to obtain a solid product: and heating the solid product at 500° C. or higher.

In the method, an average particle diameter of the titania particles may be 3 to 100 nm, and a ratio of the titania particles to the titania particle-layered clay mineral complex may be 0.1 to 0.8 on a mass basis.

In the method, the hydrolyzable group may carry 1 to 15 carbon atoms.

Moreover, in accordance with one or more embodiments of the invention, a friction material is provided with a friction modifier produced by the method is free from an antimony compound.

The friction material may include: 0.5 to 20% by mass of the friction modifier; a fiber reinforcement; a binder resin; and a filler.

According to the embodiments of the invention, it is possible to provide a porous friction modifier by which a wear amount in sliding at a high temperature of a friction material can be reduced and a decrease in the friction coefficient of a friction material can be inhibited without resorting to use an antimony compound. According to the embodiments of the invention, moreover, it is possible to provide a method of producing the friction modifier as described above and a friction material containing the above friction modifier.

Other aspects and advantages of the invention will be apparent from the following description, the drawings and the claims.

### DETAILED DESCRIPTION OF THE EMBODIMENTS

In an exemplary embodiment of the invention, a friction modifier includes a titania particle-layered clay mineral complex in which titania particles are contained in a layered clay mineral. In the friction modifier, an average particle diameter of the titania particles is 3 to 100 nm and a ratio of the titania particles to the titania particle-layered clay mineral complex is 0.1 to 0.8 on the mass basis.

As the layered clay mineral in the friction modifier of the exemplary embodiment, a natural clay mineral and a synthetic clay mineral having a cation exchange ability may be adopted. Examples of the natural clay mineral and synthetic clay mineral include kaolinite, smectites, vermiculite, mica, brittle mica, chlorite and so on. Examples of the smectites include montmorillonite, saponite, beidellite, nontronite and so on.

Furthermore, the mica may be a synthetic fluoromica that is obtained by treating mica with fluorine. This synthetic fluoromica is preferred as the layered clay mineral because of showing little variation in qualities. An example of the synthetic fluoromica may be sodium type tetrasilicate mica (NaMg_{2.5}Si₄O₁₀F₂). Either one of these layered clay minerals or a combination of two or more kinds thereof may be used.

As the titania particles in the friction modifier, crystalline titania particles are preferred and those having the main crystalline phase of the anatase type and those having an anatase-rutile crystalline phase are preferred.

In the friction modifier, the average particle diameter of the titania particles is 3 to 100 nm, preferably 5 to 80 nm and more preferably 8 to 50 nm. The term “average particle diameter” as used herein means “volume-average particle diameter” and the volume-average particle diameter can be measured using, for example, an electron microscope.

In the friction modifier, the ratio of the titania particles to the titania particle-layered clay mineral complex is 0.1 to 0.8, preferably 0.2 to 0.7 and more preferably 0.3 to 0.65 on the mass basis.

Because the friction modifier contain the titania particles having a specific particle diameter at a specific ratio, the friction modifier can reduce a wear amount in sliding at a high temperature of a friction material and inhibit a decrease in the friction coefficient of a friction material without resorting to use an antimony compound.

In the friction modifier, it is preferable that the titania particle-layered clay mineral complex has a structure wherein titania particles are inserted between the layers of the layered clay mineral.

The titania particle-layered clay mineral complex constituting the friction modifier of the exemplary embodiment is a porous material in which a number of mesopores having a pore diameter larger than 2 nm but not larger than 50 nm are formed among layers.

It is preferable that the titania particle-layered clay mineral complex constituting the friction modifier has an average pore diameter measured under an electron microscope of 2 to 80 nm, more preferably 3 to 50 nm and still more preferably 5 to 30 nm. It is preferable that the titania particle-layered clay mineral complex has a specific surface area measured by the nitrogen adsorption method of 10 to 300 m²/g, more preferably 15 to 250 m²/g and still more preferably 20 to 200 m²/g.

Because the friction modifier has a number of mesopores, the friction modifier can maintain the friction coefficient at a high level.

It is considered that, in the friction modifier of the exemplary embodiment, titania particles are inserted among the layers of the layered clay mineral and thus enlarge the interlayer distance, which contributes to the formation of the porous structure wherein a number of micropores having a pore diameter of 2 nm or below and mesopores having a pore diameter larger than 2 nm but not larger than 50 nm are formed.

In the friction modifier, it is preferable that the average particle diameter is 1 to 30 μm, more preferably 1 to 10 μm and still more preferably 1 to 5 μm.

Next, the method of producing the friction modifier of the exemplary embodiment will be described.

The friction modifier is produced by bringing a titanium compound having a hydrolyzable group or a hydroxyl group and carrying 0 to 60 carbon atoms in total in its molecule into contact with a layered clay mineral in an aqueous medium, obtaining solid product, and heating the obtained solid product at 500° C. or higher to thereby obtain the friction modifier containing the titania particle-layered clay mineral complex.

Examples of the layered clay mineral that is used as a starting material in the method of the exemplary embodiment may include those cited in the above with respect to the friction modifier.

As the titanium compound as described above, it is preferable to use a compound represented by the formula:

RₙTiX₄₋ₙ

wherein n is an integer of from 0 to 3; R represents a hydrocarbon group optionally having a functional group; and X represents a hydrolyzable group or a hydroxyl group, provided that in the case where there are two or more R's or X's, these R's or X's may be either the same or different and the total carbon atom number in R and X is 0 to 60.

In the titanium compound represented by the above formula RₙTiX₄₋ₙ, n is an integer of from 0 to 3, preferably an integer of from 0 to 2 and more preferably an integer of 0 or 1.

In the titanium compound represented by the above formula RₙTiX₄₋ₙ, R is a hydrocarbon group. Examples of the hydrocarbon group include a saturated or unsaturated aliphatic hydrocarbon group having straight or branched chain, an aromatic hydrocarbon group and an alicyclic hydrocarbon group. Such a hydrocarbon group may be either a monovalent or polyvalent one.

With respect to the carbon atom number, the carbon atom number of an aliphatic hydrocarbon group is preferably 1 to 15 and particularly preferably 1 to 10, that of an aromatic hydrocarbon group is 6 to 15 and particularly preferably 6 to 10, and that of an alicyclic hydrocarbon group is 3 to 15 and particularly preferably 3 to 10.

The hydrocarbon group may have a functional group. Examples of the functional group include a vinyl group, an ester group, an ether group, an epoxy group, an amino group, a carboxyl group, a carbonyl group, an amide group, a mercapto group, a sulfonyl group, a sulfenyl group, a nitro group, a nitroso group, a nitrile group, a halogen atom, a hydroxyl group and so on.

In the case where the above titanium compound has two or more R's, these R's may be either the same or different.

In the titanium compound represented by the above formula RₙTiX₄₋ₙ, X is a hydrolyzable group or a hydroxyl group. As the hydrolyzable group, one having 1 to 15 carbon atoms, more preferably 2 to 10 carbon atoms and still more preferably 3 to 8 carbon atoms, is preferred.

Examples of the hydrolyzable group include an alkoxy group, an alkenyloxy group, a ketoxime group, an acyloxy group, an amino group, an aminoxy group, an amide group and a halogen atom. Preferable examples of the alkoxy group include a methoxy group, an ethoxy group, a propoxy group, a butoxy group and so on. Preferable examples of the alkenyloxy group include a vinyloxy group, an allyloxy group, a propenyloxy group and so on. Preferable examples of the acyloxy group include a formyloxy group, an acetyloxy group, a propionyloxy group and so on.

In the case where the above titanium compound has two or more X's, these X's may be either the same or different.

In the titanium compound represented by the above formula RₙTiX₄₋ₙ, the total carbon atom number in R and X is from 0 to 60, preferably from 4 to 40 and more preferably from 4 to 30.

As the titanium compound represented by the above formula RₙTiX₄₋ₙ, a tetraalkoxy titanium is preferred and specific examples thereof include tetramethoxy titanium, tetraethoxy titanium, tetrapropoxy titanium, tetrabutoxy titanium, isopropyl triisostearoyl titanate, titanium tetrachloride and so on.

Either one of the titanium compounds as cited above or a combination of two or more kinds thereof may be used.

In the method of the exemplary embodiment, it is preferable to use the titanium compound in such a manner that, after the completion of the heating treatment, the ratio by mass of the titania particles to the titania particle-layered clay mineral complex amounts to 0.1 to 0.8, more preferably 0.2 to 0.7 and still more preferably 0.3 to 0.65.

In the method of the exemplary embodiment, the layered clay mineral and the titanium compound are contacted with each other in an aqueous medium. Examples of the aqueous medium include water, a mixture of water with a lower alcohol (methanol, ethanol, etc.) and so on.

In the method of the exemplary embodiment, the layered clay mineral may be contacted with the titanium compound by, for example, dispersing the layered clay mineral having been swollen in water, etc. and mixing the dispersion with the titanium compound having been diluted with an aqueous acetic acid solution, etc. while stirring at room temperature or under heating.

In the case where the layered clay mineral is swollen and dispersed in water, the concentration of the layered clay mineral is preferably 0.1 to 5% by mass, more preferably 0.5 to 3% by mass and still more preferably 1 to 2% by mass.

In the step of mixing the layered clay mineral with the titanium compound, an additive such as a blowing agent or a dispersant may be further added. Examples of the blowing agent include sodium bicarbonate, azodicarbonamide, N,N′-dinitrosopentamethyltetramine and so on. Examples of the dispersant include sodium hexametaphosphate, sodium pyrophosphate and so on.

The layered clay mineral has a fibrous or planar crystalline structure that is maintained up to about 1000° C. In the case of reacting the layered clay mineral with the titanium compound by the method as described above, the mixing and stirring temperatures should be determined by taking the heat resistance of the hydrophobic group in the titanium compound into consideration. Accordingly, the temperature at which the layered clay mineral and the titanium compound are reacted preferably ranges from room temperature to about 100° C. The reaction time preferably ranges form 10 to 300 minutes.

After bringing the layered clay mineral into contact with the titanium compound by the method as described above, the solid product thus obtained is heated at 500° C. or higher. It is preferable that the heating temperature is 700° C. or higher. Although a higher heating temperature is the more preferable, it is preferable that the heating temperature is not higher than 900° C. from the standpoint of the durability of an oven that is used in the heating treatment. The heating time preferably ranges from 0.5 to 72 hours, more preferably from 1 to 24 hours and still more preferably form 2 to 12 hours.

After heating as described above, the solid product may be ground and classified. Thus, a titania particle-layered clay mineral complex having a desired particle diameter can be obtained.

Next, the friction material of the exemplary embodiment will be described.

The friction material of the exemplary embodiment contains the above friction modifier or a friction modifier produced by the above method. The friction material is free from an antimony compound. The preferred mode of the friction modifier to be used in the friction material of the exemplary embodiment is as described with respect to the friction modifier and the method of producing a friction modifier.

Because the friction material contains the above friction modifier or a friction modifier obtained by the above method and is free from an antimony compound, the friction material can reduce the environmental load while inhibiting a decrease in the friction coefficient.

It is preferable that the friction material contains 0.5 to 20% by mass of the friction modifier as described above together with a fiber reinforcement, a binder resin and a filler.

It is preferable that the friction material contains 1 to 15% by mass, more preferably 2 to 10% by mass, of the friction modifier.

Examples of the fiber reinforcement in the friction material include a reinforcement made of an organic fiber and a reinforcement made of an inorganic fiber.

Examples of the reinforcement made of an organic fiber include those made of a high-strength aromatic polyamide fiber (aramid fiber), a flame-retardant acrylic fiber, a polyimide fiber, a polyacrylate fiber, a polyester fiber and so on. As an example of the aramid fiber, KEVLAR manufactured by Dupont can be cited.

On the other hand, examples of the reinforcement made of an inorganic fiber include those made of an inorganic fiber such as a potassium titanate fiber, a silicon carbide fiber and a wollastonite fiber, glass fiber, carbon fiber, a ceramic fiber such as an alumina silica-based fiber, and a metal fiber such as an aluminum fiber, a stainless fiber, a copper fiber a brass fiber and a nickel fiber.

In the friction material, the content of the fiber reinforcement is preferably 2 to 50% by mass, more preferably 3 to 40% by mass and still more preferably 5 to 30% by mass.

Examples of the binder resin in the friction material include one or more resins selected from among a thermosetting resin such as an epoxy resin, a polyester resin, a mixture of an epoxy resin with a polyester resin and an acrylic resin, and a thermoplastic resin such as polyvinyl chloride and polyvinyl butyral.

Examples of the epoxy resin usable as the binder resin in the friction material include a glycidyl ether type resin such as a condensation product of bisphenol A with epichlorohydrin or a condensation product of bisphenol F with epichlorohydrin, a glycidyl ester resin and an epoxy resin such as an alicyclic epoxy resin, an aliphatic epoxy resin, a bromoepoxy resin, a phenol-novolac resin or a cresol-novolac resin. Among these epoxy resins, a glycidyl ether type resin such as a condensation product of bisphenol A with epichlorohydrin or a condensation product of bisphenol F with epichlorohydrin is preferred.

More specifically speaking, examples thereof include EPOTOHTO YD903N, YD128, YD14, PN639, CN701, NT114, ST-5080, ST-5100 and ST-4100D manufactured by Tohto Kasei Co., Ltd.; EITPA 3150 manufactured by Daicel Chemical Industries, Ltd.; ARALDITE CY179, PT810, PT910 and GY6084 manufactured by Ciba-Geigy; DENACOL EX711 manufactured by NAGASE CHEMTEX Co.; EPICLON 4055RP, N680, HP4032, N695 and HP7200H manufactured by DAINIPPON INK & CHEMICALS, Inc., EPICOAT 1001, 1002, 1003, 1004 and 1007 manufactured by Yuka-Shell Epoxy Co., Ltd.; DER662 manufactured by The Dow Chemical Company; EPPN 201, EPPN 202, EOCN 1020 and EOCN 102S manufactured by Nippon Kayaku Co., Ltd.; and so on.

Examples of the polyester resin usable as the binder resin in the friction material include those obtained by polymerizing a polyhydric alcohol such as ethylene glycol, propanediol, hexanediol, neopentyl glycol, trimethylol propane or pentaerythritol with a carboxylic acid such as maleic acid, terephthalic acid, isophthalic acid, phthalic acid, succinic acid glutaric acid, adipic acid, sebacic acid or β-oxypropionic acid in accordance with a method commonly employed in the art.

It is preferable that the number-average molecular weight of the polyester resin is 500 to 100,000, more preferably 2,000 to 80,000. It is preferable that the hydroxyl value of the polyester resin is 0 to 300 mgKOH/g, more preferably 30 to 120 mgKOH/g. It is preferable that the acid value of the polyester resin is 0 to 200 mgKOH/g, more preferably 10 to 100 mgKOH/g. It is preferable that the melting point of the polyester resin is 50 to 200° C., more preferably 80 to 150° C.

Specific examples thereof include CRYLCOAT 341, 7620 and 7630 manufactured by DAICEL UCB Co., Ltd.; FINEDICK M-8010, 8020, 8024 and 8710 manufactured by DAINIPPON INK & CHEMICALS, Inc.; UPICACOAT GV110 and 230 manufactured by UPICA Co., Ltd.; ER6570 manufactured by NIPPON-ESTER Co., Ltd.; VESTAGON EP-P100 manufactured by HUELS AG; and so on.

Examples of the mixture of an epoxy resin with a polyester resin usable as the binder resin in the friction material include one prepared by mixing the above-described epoxy resin with the above-described polyester resin each in a definite amount. In the mixture of the epoxy resin with the polyester resin, it is preferable that the content of the polyester resin is 10 to 90% by mass, more preferably 20 to 70% by mass and still more preferably 30 to 50% by mass based on the total composition.

Examples of the acrylic resin usable as the binder resin in the friction material include a polymer of acrylic acid or its derivative and a copolymer of the acrylic acid or its derivative with another monomer, e.g., those obtained by radical-polymerizing a monomer of acrylic acid or its derivative such as acrylic acid, methacrylic acid, methyl methacrylate, ethyl methacrylate, glycidyl acrylate or n-butyl acrylate optionally together with another monomer such as styrene with the use of a radical polymerization initiator such as azobisisobutyronitrile or benzoyl peroxide. Specific examples thereof include SANPEX PA-70 manufactured by Sanyo Chemical Industries.

Examples of the polyvinyl chloride usable as the binder resin in the friction material include a homopolymer of vinyl chloride monomer and copolymers of a vinyl chloride monomer with another monomers and use can be made of various commercially available polyvinyl chloride products. Specific examples thereof include products of V-Tech Corporation, Kaneca Corporation, Shin-Etsu Chemical Co., Ltd., Shin Dai-Ichi Vinyl Corporation, Taiyo vinyl Co., Ltd. and TOSOH CORPORATION. In the case of synthesizing polyvinyl chloride by polymerizing a vinyl chloride monomer by using the granular or emulsion polymerization method, examples of the vinyl chloride monomer usable therein include products of V-Tech Corporation, Kashima Vinyl Chloride Monomer Co., Ltd., Kaneca Corporation, Keiyo Monomer Co., Ltd., TOSOH CORPORATION and TOKUYAMA Corp.

The polyvinyl butyral usable as the binder resin in the friction material is a polymer prepared by adding butyl aldehyde to polyvinyl alcohol, and a specific example thereof is S-LEC manufactured by SEKISUI CHEMICAL CO., LTD.

When the friction material contains a thermosetting resin as the binder resin, it may further contain a curing agent. Examples of the curing agent include curing agents of polyamine type, aminoamide type, blocked isocyanate type, triglycidyl isocyanurate (TGIC) type, and epoxy type (e.g., polyepoxide, epoxy resin). Among these agents, curing agents of polyamine type, aminoamide type and blocked isocyanate type are particularly preferred.

In the friction material, it is preferable that the content of the binder resin is 2 to 20% by mass, more preferably 3 to 18% by mass and still more preferably 5 to 15% by mass.

The resin coating to be used in the invention may further contain an appropriate pigment, such as a coloring pigment, a rust-inhibiting pigment or an extender. Specific examples of the coloring pigment include titanium oxide, iron oxide, carbon black, Phthalocyanine Blue, Phthalocyanine Green, a quinacridone pigment, an azo pigment and so on. Specific examples of the rust-inhibiting pigment include a chrome pigment, a phosphate pigment, a molybdate pigments and so on. Specific examples of the extender include talc, silica, alumina, calcium carbonate, precipitated barium sulfate and so on.

Examples of the filler usable in the friction material include those consisting of organic particles or inorganic particles.

Examples of the filler consisting of organic particles include a rubber powder, a cashew powder and so on.

Examples of the filler consisting of inorganic particles include those made of one or more materials selected from among barium sulfate, calcium carbonate, mica, graphite, tin sulfate, tungsten disulfide, zirconia, alumina, silica, magnesium sulfate, iron oxide, copper, aluminum, zinc, brass and cast iron.

In the friction material, it is preferable that the content of the filler is 0 to 70% by mass, more preferably 5 to 60% by mass and still more preferably 10 to 50% by mass.

As the method of producing the friction material, there can be enumerated a method wherein the above friction modifier, the fibrous reinforcement and the filler are appropriately molten and kneaded together in the presence of the binder resin.

### EXAMPLES

The exemplary embodiment of the invention will be illustrated in greater detail by referring to the following Examples, although the invention is not restricted to these Examples.

### Example 1

### Example of the Production of Friction Modifier

A synthetic fluoromica (ME-100 manufactured by CO-OP CHEMICAL Co., Ltd), i.e., a layered clay mineral was supplied into distilled water, i.e., an aqueous medium and swollen and dispersed by stirring at room temperature for 24 hours. Thus, a f synthetic fluoromica liquor containing 1% by mass of the synthetic fluoromica was prepared.

Separately, acetic acid was added to distilled water, i.e. r an aqueous medium to give an 80% by mass aqueous acetic acid solution. To this aqueous acetic acid solution, tetrabutoxy titanium was added to give a concentration of 0.5 M. After stirring at 60° C. for 1 hour, the mixture was cooled to give a titania sol-containing liquor.

By using the synthetic fluoromica liquor and the titania sol-containing liquor as described above, a liquid mixture was prepared in such a manner that, after the heating treatment, the ratio by mass of the titania particles to the titania particle-layered clay mineral complex was controlled to 0.65. After stirring at room temperature for 3 hours, the mixture was centrifuged and the precipitate was collected. After repeatedly washing with distilled water and centrifuging until the pH value exceeded 5, the precipitate was heated at 900° C. for 72 hours. Thus, a friction modifier comprising the titania particle-layered clay mineral complex was obtained.

The average particle diameter of the titania particles in the titania particle-layered clay mineral complex and the average pore diameter of the titania particle-layered clay mineral complex that were determined by measuring the section of the friction modifier under an electron microscope (HD-2000 manufactured by Hitachi Hi-Tech) were 30 nm and 20 nm respectively.

The specific surface area of the layered clay mineral complex determined by the nitrogen adsorption method was 22.9 m²/g. Table 1 shows the results.

### Example 2

### Example of the Production of Friction Modifier

The procedure of Example 1 was followed but using tetraethoxy titanium as a substitute for the tetrabutoxytitanium, mixing the synthetic fluoromica liquor with the titania sol-containing liquor in such a manner that after the heating treatment, the ratio by mass of the titania particles to the titania particle-layered clay mineral complex was controlled to 0.35, and heating the obtained precipitate at 600° C. for 72 hours, thereby give a friction modifier comprising a titania particle-layered clay mineral complex.

The average particle diameter of the titania particles and the average pore diameter and the specific surface area of the layered clay mineral complex, each determined as in Example 1 but using the friction modifier obtained above, were 25 nm, 15 nm and 42.4 m²/g respectively. Table 1 shows the results.

### Example 3

### Example of the Production of Friction Modifier

A synthetic fluoromica (ME-100 manufactured by CO-OF CHEMICAL Co., Ltd), i.e., a layered clay mineral was supplied into distilled water, i.e., an aqueous medium and swollen and dispersed by stirring at room temperature for 24 hours. Thus, a synthetic fluoromica liquor was prepared.

Separately, 300 g of acetic acid was added to 100 g of distilled water, i.e., an aqueous medium to give an aqueous acetic acid solution. To this aqueous acetic acid solution, 30 g of titanium tetraisopropoxide was added. After deflocculating by stirring at 50° C. for 1 hour, the mixture was stirred at room temperature for additional 1 hour give a deflocculated titania sol liquor.

By using the synthetic fluoromica liquor and the deflocculated titania sol liquor as described above, a liquid mixture was prepared in such a manner that, after the heating treatment, the ratio by mass of the titania particles to the titania particle-layered clay mineral complex was controlled to 0.5. After stirring at room temperature for 2 hours, the mixture was centrifuged and the precipitate was washed with water and dried under reduced pressure at room temperature for 24 hours. Next, it was heated at 700° C. for 8 hours. Thus, a friction modifier comprising the titania particle-layered clay mineral complex was obtained.

The average particle diameter of the titania particles and the average pore diameter and the specific surface area of the layered clay mineral complex, each determined as in Example 1 but using the friction modifier obtained above, were 15 nm, 10 nm and 104.8 m² μg respectively. Table 1 shows the results.

### Comparative Example 1

### Example of the Production of Comparative Friction Modifier

The procedure of Example 1 was followed but using a liquid mixture prepared in such a manner that after the heating treatment, the ratio by mass of the titania particles to the titania particle-layered clay mineral complex was controlled to 0.3, and heating the obtained precipitate at 400° C. for 72 hours, thereby give a friction modifier comprising a titania particle-layered clay mineral complex.

When the average particle diameter of the titania particles was measured by analyzing the obtained friction modifier with an X-ray diffractometer (manufactured by Shimadzu), the interlayer distance of the layered material was 2.5 nm. Thus, average particle diameter was estimated as 2.5 nm.

The average pore diameter and the specific surface area of the layered clay mineral complex determined by the nitrogen adsorption method were 2.1 nm and 323.8 m²/g respectively. Table 1 shows the results.

### Comparative Example 2

### Example of the Production of Comparative Friction Modifier

The procedure of Example 1 was followed but using tetraoctadecyloxy titanium as a substitute for the tetrabutoxy titanium, preparing a liquid mixture in such a manner that after the heating treatment, the ratio by mass of the titania particles to the titania particle-layered clay mineral complex was controlled to 0.4, and heating the obtained precipitate at 500° C. for 72 hours, thereby give a friction modifier comprising a titania particle-layered clay mineral complex.

The average particle diameter of the titania particles and the average pore diameter and the specific surface area of the layered clay mineral complex were determined as in Comparative Example 1 but using the friction modifier obtained above. Table 1 shows the results.

TABLE 1

| | | | Properties of friction modifier | | | |
|---|---|---|---|---|---|---|
| | Production conditions | | | Diameter of | | Specific surface |
| | | Heating | Ratio by mass | titania | Average pore | area of layered |
| | | temp. | of titania | particles | diameter of layered | mineral complex |
| | Titanium compound | (° C.) | particles*¹ | (nm) | mineral complex (nm) | (m²/g) |
| Example 1 | Tetrabutoxy | 900 | 0.65 | 30 | 20 | 22.9 |
| | titanium | | | | | |
| Example 2 | Tetraethoxy | 600 | 0.35 | 25 | 15 | 42.4 |
| | titanium | | | | | |
| Example 3 | Titanium | 700 | 0.5 | 15 | 10 | 104.8 |
| | tetraisopropoxide | | | | | |
| Comparative | Tetrabutoxy | 400 | 0.3 | 2.5*² | 2.1*³ | 323.8 |
| Example 1 | titanium | | | | | |
| Comparative | Tetraoctadecyloxy | 500 | 0.4 | 2.1*² | 1.9*³ | 421.5 |
| Example 2 | titanium | | | | | |

*¹Ratio by mass of titania particles constituting layered clay mineral complex (mass of titania particles/titania particles − mass of layered clay mineral complex)/
*²Estimated based on the data obtained by using an X-ray diffractometer.
*³Determined by the nitrogen adsorption method.

Table 1 indicates that the friction modifiers obtained in Examples 1 to 3 showed larger layered clay mineral complex pore diameters than the friction modifiers obtained in Comparative Examples 1 and 2 and, therefore, had a porous structure having a large number of mesopores formed therein.

### Example 4

### Example of the Production of Friction Material

### (1) Production of Friction Material

As the components of a friction material, the friction modifier obtained in Example 1 and the following starting materials were mixed at the ratio as shown below. Next, the resultant mixture was heat-molded at 150° C. for 10 minutes under a pressure of 30 MPa followed by heating at 250° C. for additional 3 hours. By using the material thus obtained, a plate type friction material of 65 mm in length, 50 mm in width and 10 mm in thickness was produced.

### (Composition of Friction Material)

| | |
|---|---|
| Friction modifier | 3 parts by weight |
| Phenol resin | 15 parts by weight |
| Rubber dust | 7 parts by weight |
| Barium sulfate | 35 parts by weight |
| Zirconia | 1 part by weight |
| Scale graphite | 4 parts by weight |
| Aramid pulp | 10 parts by weight |
| Inorganic fiber | 15 parts by weight |
| Metal powder | 10 parts by weight |

### (2) Wear Test

By using the friction material obtained in (1) above, the amount of wear (mm) was measured by setting the initial speed of braking to 50 km/h, the deceleration of braking to 0.3G, the number of braking to 200 and the brake temperature to 100° C. and 400° C. As a result, the amounts of wear were 0.04 mm (at 100° C.) and 0.19 mm (at 400° C.). Table 2 shows the results.

### (3) Fade Test

By using the friction material obtained in (1) above, the minimum friction coefficient was measured by setting the initial speed of braking to 100 km/h, the deceleration of braking to 0.45 G and the number of braking to 9. As a result, the minimum friction coefficient was 0.27. Table 3 shows the results.

### Example 5

### Example of the Production of Friction Material

### (1) Production of Friction Material

The procedure of Example 4 (1) was followed but using the friction modifier obtained in Example 2 as a substitute for the friction modifier obtained in Example 1 as the component of the friction material to give a friction material.

### (2) Wear Test

By using the friction material obtained in (1) above, a wear test was conducted as in Example 4 (2). As a result, the amounts of wear were 0.04 mm (at 100° C.) and 0.21 mm (at 400° C.). Table 2 shows the results.

### (3) Fade Test

By using the friction material obtained in (1) above, a fade test was conducted as in Example 4(3). As a result, the minimum friction coefficient was 0.27. Table 3 shows the results.

Comparative Example 3 (Example of the production of comparative friction material)

### (1) Production of Friction Material

The procedure of Example 4 (1) was followed but using the friction modifier obtained in Comparative Example 1 as a substitute for the friction modifier obtained in Example 1 as the component of the friction material to give a friction material.

### (2) Wear Test

By using the friction material obtained in (1) above, a wear test was conducted as in Example 4(2). As a result, the amounts of wear were 0.05 mm (at 100° C.) and 0.23 nm (at 400° C.). Table 2 shows the results.

### (3) Fade Test

By using the friction material obtained in (1) above, a fade test was conducted as in Example 4(3). As a result, the minimum friction coefficient was 0.26. Table 3 shows the results.

### Comparative Example 4

### Example of the Production of Comparative Friction Material

### (1) Production of Friction Material

The procedure of Example 4 (1) was followed but using the friction modifier obtained in Comparative Example 2 as a substitute for the friction modifier obtained in Example 1 as the component of the friction material to give a friction material.

### (2) Wear Test

By using the friction material obtained in (1) above, a wear test was conducted as in Example 4(2). As a result, the amounts of wear were 0.06 mm (at 100° C.) and 0.27 mm (at 400° C.). Table 2 shows the results.

### (3) Fade Test

By using the friction material obtained in (1) above, a fade test was conducted as in Example 4(3). As a result, the minimum friction coefficient was 0.23. Table 3 shows the results.

TABLE 2
Wear test results (wear amount of friction material)

| | | | Comparative | Comparative |
|---|---|---|---|---|
| | Example 4 | Example 5 | Example 3 | Example 4 |
| 100° C. | 0.04 mm | 0.04 mm | 0.05 mm | 0.06 mm |
| 400° C. | 0.19 mm | 0.21 mm | 0.23 mm | 0.27 mm |

TABLE 3
Fade test results

| | | | Comparative | Comparative |
|---|---|---|---|---|
| | Example 4 | Example 5 | Example 3 | Example 4 |
| Minimum | 0.27 | 0.27 | 0.26 | 0.23 |
| friction | | | | |
| coefficient | | | | |

As Table 2 shows, the wear amounts of the friction materials obtained in Examples 4 and 5 are smaller than the wear amounts of the friction materials obtained in Comparative Examples 3 and 4, which indicates that the friction material according to the invention can reduce the wear amount in sliding at a high temperature.

As Table 3 shows, the minimum coefficients of friction of the friction materials obtained in Examples 4 and 5 are larger than the minimum coefficients of friction of the friction materials obtained in Comparative Examples 3 and 4, which indicates that the friction material according to the invention can inhibit a decrease in the friction coefficient.

According to the exemplary embodiment of the invention, it is possible to provide a porous friction modifier by which the wear amount in sliding at a high temperature of a friction material can be reduced and a decrease in the friction coefficient of a friction material can be inhibited without resorting to use an antimony compound. According to the exemplary embodiment of the invention, it is also possible to provide a method of producing the friction modifier as described above and a friction material containing the above friction modifier.

While description has been made in connection with specific exemplary embodiment of the invention, it will be obvious to those skilled in the art that various changes and modification may be made therein without departing from the present invention. It is aimed, therefore, to cover in the appended claims all such changes and modifications falling within the true spirit and scope of the present invention.

What is claimed is:

1. A friction modifier comprising:
a titania particle-layered clay mineral complex in which titania particles are contained in a layered clay mineral,
wherein an average particle diameter of the titania particles is 3 to 100 nm, and a ratio of the titania particles to the titania particle-layered clay mineral complex is 0.1 to 0.8 on a mass basis.

2. A friction material which comprises the friction modifier according to claim 1 and is free from an antimony compound.

3. The friction material according to claim 2, comprising: 0.5 to 20% by mass of the friction modifier;
a fiber reinforcement;
a binder resin; and
a filler.

4. A method of producing a friction modifier including a titania particle-layered clay mineral complex in which titania particles are contained in a layered clay mineral, the method comprising;
bringing a titanium compound having a hydrolyzable group or a hydroxyl group and carrying 0 to 60 carbon atoms in total in its molecule into contact with a layered clay mineral, in an aqueous medium, to obtain a solid product; and
heating the solid product at 500° C. or higher.

5. The method according to claim 4, wherein the hydrolyzable group carries 1 to 15 carbon atoms.

6. A friction material which comprises a friction modifier produced by the method according to claim 4 and is free from an antimony compound.

7. The friction material according to claim 6, comprising
0.5 to 20% by mass of the friction modifier;
a fiber reinforcement,
a hinder resin; and
a filler.
